(19) United States
(12) Patent Application Publication
(10) Pub. No.: US 2015/0271195 A1
(43) Pub. Date: Sep. 24, 2015

(54) METHOD AND SYSTEM FOR PROVIDING TEMPORARY SECURE ACCESS ENABLED VIRTUAL ASSETS

(71) Applicant: Intuit Inc., Mountain View, CA (US)

(72) Inventors: M. Shannon Lietz, San Marcos, CA (US); Luis Felipe Cabrera, Bellevue, WA (US); Bond Masuda, Chula Vista, CA (US)

(73) Assignee: INTUIT INC., Mountain View, CA (US)

(21) Appl. No.: 14/217,653

(22) Filed: Mar. 18, 2014

(51) Int. Cl. H04L 29/06

(52) U.S. Cl. CPC H04L 63/1433; H04L 63/08

(57) ABSTRACT

Temporary secure access enabled virtual assets are provided that include a temporary secure access communications door. Upon receipt of temporary access authentication data from a source outside the temporary secure access enabled virtual asset, the temporary secure access communications door temporarily allows operational instruction code to be transferred into the temporary secure access enabled virtual asset from a source outside temporary secure access enabled virtual asset.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributive computing models. This is because many owners and operators of data centers that provide access to data and other resources are extremely hesitant to allow their data and resources to be accessed, processed, and/or otherwise used, by virtual assets in the cloud.

In a cloud computing environment, various virtual assets, such as, but not limited to, virtual machine instances, data stores, and various services, are created, launched, or instantiated, in the cloud for use by an “owner” of the virtual asset, herein also referred to as a user of the virtual asset.

Herein the terms “owner” and “user” of a virtual asset include, but are not limited to, applications, systems, and sub-systems of software and/or hardware, as well as persons or entities associated with an account number, or other identity, through which the virtual asset is purchased, approved managed, used, and/or created.

One major security issue in a cloud computing environment is that vulnerabilities associated with virtual assets are not always known or understood at the time the virtual assets are created and deployed, e.g., instantiated, in a given computing environment and, once deployed, responding to newly identified vulnerabilities through “normal” communications channels associated with the virtual assets can be challenging, if not impossible.

In addition, in some cases, a malicious entity is able to take control of a virtual asset. In these cases, the malicious entity often takes over, or closes down, normal communications channels associated with the virtual asset. Consequently, in some cases, the malicious entity can mask the fact they have taken control of the virtual asset, and/or be left relatively free to manipulate the virtual asset under its control and access any data used by the virtual asset, with little immediate recourse for the legitimate owner of the virtual asset. Even in cases where the legitimate owner of the virtual asset does become aware that the virtual asset has been compromised, if the malicious entity has shut down, or taken control of, the normal communications channels associated with the virtual asset, the malicious entity can thwart any traditional efforts by the legitimate owner to communicate with the virtual asset and/or repair the virtual asset. Consequently, the legitimate owner may still be unable to take any immediate action or, at best, has no option but to destroy the virtual asset; thereby potentially losing any data within the virtual asset.

Given that virtual assets often process and control sensitive data, the situation described above represents a significant issue that must be resolved before highly sensitive data, such as financial data, can be safely processed in a cloud computing environment.

What is needed is a method and system for allowing operational code and instructions to be dynamically, and/or reactively, provided to a virtual asset through a special communications channel to the virtual asset only accessible by a legitimate owner of the virtual asset.

### SUMMARY

In accordance with one embodiment, temporary secure access enabled virtual assets are provided that include a temporary secure access communications door for establishing a temporary secure access communication channel for use by a legitimate owner of the virtual asset. In one embodiment, upon receipt of temporary access authentication data from a source outside the temporary secure access enabled virtual asset associated with the legitimate owner, the temporary secure access communications door temporarily allows operational instruction code to be transferred into the temporary secure access enabled virtual asset from a source associated with the legitimate owner outside the temporary secure access enabled virtual asset in response to an identified vulnerability or threat.

In accordance with one embodiment, a system for providing temporary secure access enabled virtual assets includes a virtual asset monitoring system. In one embodiment, the virtual asset monitoring system includes security and response policy data indicating any identified vulnerabilities and response operations associated with identified vulnerabilities.

In accordance with one embodiment, a vulnerability response system is provided that includes temporary access authentication data and operation instruction code for implementing one or more operational responses to identified vulnerabilities indicated by the virtual asset monitoring system.

In accordance with one embodiment, one or more temporary secure access enabled virtual assets are provided. In one embodiment, each temporary secure access enabled virtual asset includes a temporary access authentication data receipt module for receiving at least part of the temporary access authentication data from the vulnerability response system.

In one embodiment, each temporary secure access enabled virtual asset also includes a temporary secure access communication door activation module which, upon receipt of at least part of the temporary access authentication data from the vulnerability response system at the temporary access authentication data receipt module, opens a temporary secure access communications door pre-deployed within the temporary secure access enabled virtual asset.

In one embodiment, once activated, e.g., opened, the temporary secure access communications door provides a temporary secure access communication channel through which the operational instruction code is transferred from the vulnerability response system into the temporary secure access enabled virtual asset. In one embodiment, the operational instruction code then facilitates the deployment of one or more operational responses to identified vulnerabilities indicated by the virtual asset monitoring system.

In one embodiment, once the operational instruction code implements one or more operational responses to identified vulnerabilities indicated by the virtual asset monitoring system, the temporary secure access communications door is de-activated, e.g., is closed, thereby shutting down the temporary secure access communication channel.

### BRIEF DESCRIPTION OF THE DRAWINGS

FIG. 1 is a functional block diagram showing the interaction of various elements for implementing one embodiment;

FIG. 2 is a functional diagram of a temporary secure access enabled virtual asset creation template in accordance with one embodiment;

FIG. 3 is a flow chart depicting a process for providing temporary secure access enabled virtual assets in accordance with one embodiment; and

FIG. 4 is a flow chart depicting a process for providing temporary secure access enabled virtual assets in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a method and system for providing temporary secure access enabled virtual assets includes a process for providing temporary secure access enabled virtual assets implemented, at least in part, by one or more computing systems.

As used herein, the term “computing system”, includes, but is not limited to, a server computing system; a workstation; a desktop computing system; a database system or storage cluster; a switching system; a router; any hardware system; any communications systems; any form of proxy system; a gateway system; a firewall system; a load balancing system; or any device, subsystem, or mechanism that includes components that can execute all, or part, of any one of the processes and/or operations as described herein.

In addition, as used herein, the term computing system, can denote, but is not limited to, systems made up of multiple server computing systems; workstations; desktop computing systems; database systems or storage clusters; switching systems; routers; hardware systems; communications systems; proxy systems; gateway systems; firewall systems; load balancing systems; or any devices that can be used to perform the processes and/or operations as described herein.

In various embodiments, the one or more computing systems implementing the processes for providing temporary secure access enabled virtual assets are logically or physically located, and/or associated with, two or more computing environments. As used herein, the term “computing environment” includes, but is not limited to, a logical or physical grouping of connected or networked computing systems using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the components, infrastructure, communication and networking systems, and security systems associated with the computing systems making up the trusted computing environment, are either under the control of, or known to, a party. In contrast, unknown, or untrusted computing environments are environments and systems where the components, infrastructure, communication and networking systems, and security systems implemented and associated with the computing systems making up the untrusted computing environment, are not under the control of, and/or are not known by, a party, and/or are dynamically configured with new elements capable of being added that are unknown to the party.

Examples of trusted computing environments include the components making up data centers associated with, and/or controlled by, a party and/or any computing systems, and/or networks of computing systems, associated with, known by, and/or controlled by, a party. Examples of untrusted computing environments include, but are not limited to, public networks, such as the Internet, various cloud-based computing environments, and various other forms of distributed computing systems.

It is often the case that a party desires to transfer data to, and/or from, a first computing environment that is an untrusted computing environment, such as, but not limited to, a public cloud, a virtual private cloud, and a trusted computing environment, such as, but not limited to, networks of computing systems in a data center controlled by, and/or associated with, the party. However, in other situations a party may wish to transfer data between two trusted computing environments, and/or two untrusted computing environments.

In one embodiment, two or more computing systems, and/or two or more computing environments, are connected by one or more communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

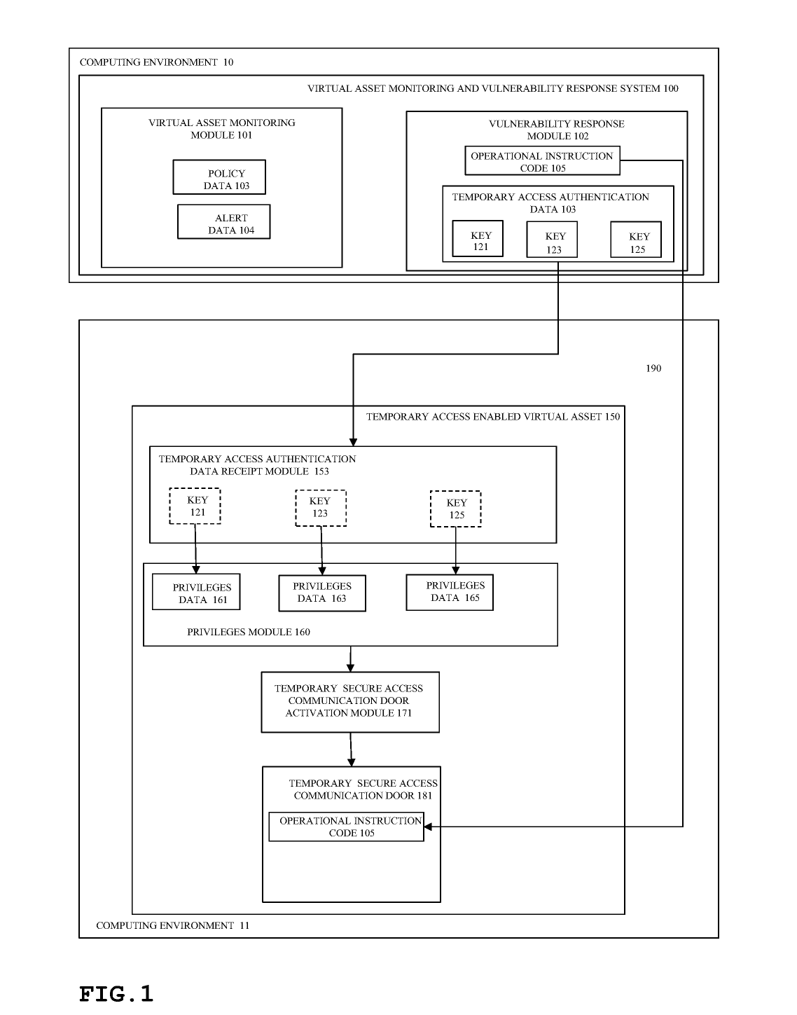

FIG. 1 is a functional diagram of the interaction of various elements associated with one embodiment of the methods and systems for providing temporary secure access enabled virtual assets discussed herein. Of particular note, the various elements in FIG. 1 are shown for illustrative purposes as being associated with specific computing environments, such as computing environment 10 and computing environment 11. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components as discussed herein, and/or as known in the art at the time of filing, and/or as developed/made available after the time of filing.

In addition, the elements shown in FIG. 1, and/or the computing environments, systems and architectural and/or infrastructure components, deploying the elements shown in FIG. 1, can be under the control of, or otherwise associated with, various parties or entities, or multiple parties or entities, such as, but not limited to, the owner of a data center, a party and/or entity providing all or a portion of a cloud-based computing environment, the owner or a provider of a service, the owner or provider of one or more resources, and/or any other party and/or entity providing one or more functions, and/or any other party and/or entity as discussed herein, and/or as known in the art at the time of filing, and/or as made known after the time of filing.

In one embodiment, a cloud computing environment is provided. In various embodiments, the provided cloud computing environment can be any form of cloud computing environment, such as, but not limited to, a public cloud; a private cloud; a virtual private network (VPN); a subnet; a Virtual Private Cloud, or VPC; a sub-net or any security/communications grouping; or any other cloud-based infrastructure, sub-structure, or architecture, as discussed herein, and/or as known in the art at the time of filing, and/or as developed after the time of filing.

In many cases, a given application or service provided through a cloud computing infrastructure may utilize, and interface with, multiple cloud computing environments, such multiple VPCs, in the course of providing the associated service. In various embodiments, each cloud computing environment includes allocated virtual assets associated with, and controlled or used by, the party utilizing the cloud computing environment.

As used herein, the term “virtual asset” includes any virtualized entity or resource, and/or part of an actual, or “bare metal” entity. In various embodiments, the virtual assets can be, but are not limited to, virtual machines, virtual servers, and instances implemented in a cloud computing environment; databases implemented, or associated with, a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

Some virtual assets are substantially similar to, or identical to, other virtual assets in that the virtual assets have the same, or similar, operational parameters such as the same, or similar, function; the same, or similar, connectivity and communication features; the same, or similar, storage capability allocated to the virtual assets; the same, or similar, processing capability allocated to the virtual assets; the same, or similar, hardware, allocated to the virtual assets; the same, or similar, software allocated to virtual assets; and/or any combination of similar, or identical, operational parameters as discussed herein, and/or as known/available in the art at the time of filing, and/or as developed/made available after the time of filing.

Typically, virtual assets that have the same, or similar, operational parameters are created using the same set of steps, instructions, processes, code, or “recipes”. Herein, the set of steps, instructions, processes, code, or recipes used to create virtual assets that have the same, or similar, operational parameters are referred to as “virtual asset creation templates.”

Examples of virtual asset creation templates include, but are not limited to, any tool and/or system for creating and managing a collection of related cloud resources that have the same, or similar, operational parameters. One specific illustrative example of such a virtual asset creation template is a cloud formation template such as any of the Amazon Web Service (AWS) cloud formation tools/templates.

Other examples of virtual asset creation templates include, but are not limited to, any configuration management tool associated with, and/or used to create, virtual assets that have the same, or similar, operational parameters. One specific illustrative example of such a virtual asset creation template is a cookbook or recipe tool such as a Chef Recipe or system.

Other examples of virtual asset creation templates include, but are not limited to, any virtual appliance used to instantiate virtual assets that have the same, or similar, operational parameters. One specific illustrative example of such a virtual asset creation template is an Amazon Machine Image (AMI).

Other examples of virtual asset creation templates include, but are not limited to, any virtual appliance, or tool, or system, or framework, used to instantiate virtual assets that have the same, or similar, operational parameters, as discussed herein, and/or as known/available in the art at the time of filing, and/or as developed/made available after the time of filing.

Herein virtual assets that have the same, or similar, operational parameters and are created by the same virtual asset creation template are generically referred to as virtual assets of the same “class.” Examples of virtual asset classes include, but are not limited to, virtual machine classes; virtual server classes; virtual database or data store classes; specific types of instances instantiated in a cloud environment; application development process classes; and application classes.

In one embodiment, temporary secure access enabled virtual assets are provided. In one embodiment, the temporary secure access enabled virtual assets include a pre-deployed temporary secure access communications door for establishing a temporary secure access communication channel for use by a legitimate owner of the temporary secure access enabled virtual asset.

In one embodiment, the temporary secure access communication door included in the temporary secure access enabled virtual asset remains dormant, or inactive, until such time as temporary access authentication data is received from a source outside the temporary secure access enabled virtual asset.

In one embodiment, once the authentication data is received by the temporary secure access enabled virtual asset, the temporary secure access communication door is activated, e.g., the temporary secure access communication door is “opened”, to provide a temporary secure access communication channel. In one embodiment, the temporary secure access communication channel temporarily allows operational instruction code to be transferred into the temporary secure access enabled virtual asset from a source outside the temporary secure access enabled virtual asset.

In one embodiment, the operational instruction code then facilitates the deployment of one or more operational responses to identified vulnerabilities.

As noted above, FIG. 1 is a functional diagram of the interaction of various elements associated with one embodiment of the methods and systems for providing temporary secure access enabled virtual assets discussed herein. In particular, FIG. 1 shows elements of a system for providing temporary secure access enabled virtual assets.

As seen in FIG. 1, in one embodiment, a system for providing temporary secure access enabled virtual assets includes a virtual asset monitoring and vulnerability response system 100. In one embodiment, virtual asset monitoring and vulnerability response system 100 is implemented in computing environment 10 and outside temporary secure access enabled virtual asset 150.

In one embodiment, virtual asset monitoring and vulnerability response system 100 includes a virtual asset monitoring module 101 that includes policy data 103 indicating defined potential vulnerabilities and operations deployment policies to be performed in the event of the occurrence of one of the defined potential vulnerabilities.

In one embodiment, virtual asset monitoring module 101 also includes alert data 104 indicating the possibility that one or more temporary secure access enabled virtual assets, such as temporary secure access enabled virtual asset 150, has been compromised, and/or includes one of the identified potential vulnerabilities, and/or otherwise requires some form of corrective and/or protective action.

In one embodiment, virtual asset monitoring and vulnerability response system 100 further includes a vulnerability response module 102. In one embodiment, vulnerability response module 102 includes temporary access authentication data 103. In one embodiment, temporary access authentication data 103 is data not strictly connected to the normal operation and/or communications channels associated with the temporary secure access enabled virtual assets, such as temporary secure access enabled virtual asset 150, themselves, or the operating environment of the temporary secure access enabled virtual assets, but rather, as discussed in more detail below, includes special proprietary authentication data and protocols for opening a special temporary secure access communication channel 190 to the temporary secure access enabled virtual assets, such as temporary secure access enabled virtual asset 150, that is not available to other assets, architectures, structures, and parties in the computing environment of the temporary secure access enabled virtual assets, in this specific example, computing environment 11.

As specific illustrative examples, in various embodiments, temporary access authentication data 103 can include various types of secrets. As used herein, the term “secrets” includes any information, credentials, or other devices, necessary to access one or more resources and/or computing systems.

Specific illustrative examples of secrets include, but are not limited to, usernames; passwords; passphrases; encryption keys; digital certificates; multifactor authentication data; account numbers; identification numbers; and/or any other information, credentials, data, devices, and/or mechanisms used to control access to various systems, resources, file systems and any other persistent storage, and data, and that are required for such access, as discussed herein, and/or as known/available in the art at the time of filing, and/or as developed/made available after the time of filing.

In various embodiments, temporary access authentication data 103 can also include, but is not limited to, data representing: a number, such as a randomly generated number; a group of letters, such as a randomly generated group of letters; a word, such as a randomly generated password; a string of words, such as a randomly generated passphrase or nonsense phrase; data associated with the owner of the temporary access authentication enabled virtual asset, such as a serial number, identification key, or operation parameter associated with an application or service, or system that owns the temporary access authentication enabled virtual asset; personal data associated with the owner of an account associated with the temporary access authentication enabled virtual asset, such physical attributes, e.g., hair color, or hair colors, or eye color, of the owner of an account associated with the temporary access authentication enabled virtual asset, or an address, or phone number, or other personal data associated the owner of an account associated with the temporary access authentication enabled virtual asset; any form of certificate, key, or token; and/or any form of temporary access authentication data, or factors, as discussed herein, and/or as known in the art at the time of filing, and/or as developed after the time of filing.

Consequently, in one embodiment, temporary access authentication data 103 can include different types of authentication data such as, but not limited to, different temporary access authentication keys, such as exemplary key 121, key 123 and key 125 in FIG. 1.

As discussed in more detail below, in one embodiment, each different type of temporary access authentication data is associated with a different privilege, or set of privileges, to be provided when the particular type of authentication data is received.

In one embodiment, vulnerability response module 102 further includes one or more sets of operational instruction code, shown as operational instruction code 105 in FIG. 1. In one embodiment, vulnerability response module operational instruction code 105 includes instructions and data which, when deployed, or “inserted”, into the temporary secure access enabled virtual assets, such as temporary secure access enabled virtual asset 150, performs one or more corrective or protective actions within the temporary secure access enabled virtual assets.

In various embodiments, operational instruction code 105 includes data and instructions for, but not limited to, any of the following operations: performing one or more scans on all or part of the logic and data contained and/or processed by the temporary secure access enabled virtual assets, in one embodiment to attempt to identify malicious code or activity; obtaining data from the temporary secure access enabled virtual assets; destroying data within the temporary secure access enabled virtual assets; directing a transfer of data from within the temporary secure access enabled virtual assets to a location outside the temporary secure access enabled virtual assets, e.g., pulling data from the temporary secure access enabled virtual assets prior to destroying the temporary secure access enabled virtual assets; closing down one or more communications channels used by the temporary secure access enabled virtual assets; shutting down, or off, one or more capabilities of the temporary secure access enabled virtual assets; aborting one or more operations being performed by the temporary secure access enabled virtual assets; destroying the temporary secure access enabled virtual assets; and/or generating and/or transferring incorrect and/or deceptive data from the temporary secure access enabled virtual assets to a location outside the temporary secure access enabled virtual assets, such as a location or source associated with a malicious party.

As discussed in more detail below, in one embodiment, temporary access authentication data 103 is utilized to activate a temporary secure access communications door, such as temporary secure access communications door 181, pre-deployed in the temporary secure access enabled virtual assets, such as temporary secure access enabled virtual asset 150. In one embodiment, the resulting temporary secure access communication channel 190 is used to transfer at least part of operational instruction code 105 into the temporary secure access enabled virtual assets, such as temporary secure access enabled virtual asset 150.

FIG. 1 also shows temporary secure access enabled virtual asset 150. As seen in FIG. 1, temporary secure access enabled virtual asset 150 includes temporary access authentication data receipt module 153 for receiving temporary access authentication data 103 from a source outside temporary secure access enabled virtual asset 150, such as vulnerability response module 102 of virtual asset monitoring and vulnerability response system 100. As noted above, in one embodiment, temporary access authentication data 103 received at temporary access authentication data receipt module 153 can include different types of authentication data such as, but not limited to, different temporary access authentication keys, such as key 121, and/or key 123, and/or key 125.

As also seen in FIG. 1, temporary secure access enabled virtual asset 150 includes, in one embodiment, privileges module 160. In one embodiment, privileges module 160 includes privileges data 161, 163, and 165. As discussed in more detail below, in one embodiment, each different type of temporary access authentication data, such as key 121, key 123 and key 125, are associated with a different privilege, or set of privileges, such as privileges data 161, 163, and 165 to be provided when the particular type of temporary access authentication data 103, such as key 121, key 123 and key 125, is received by temporary access authentication data receipt module 153.

As seen in FIG. 1 temporary secure access enabled virtual asset 150 also includes temporary secure access communication door activation module 171. In one embodiment, once temporary access authentication data, such as key 121, key 123 and key 125 is received by temporary access authentication data receipt module 153, and correlated to the corresponding privilege, or set of privileges, such as privileges data 161, 163, and 165, temporary secure access communication door activation module 171 is used to activate, or “open”, temporary secure access communications door 181. In one embodiment, this results in the temporary enablement of temporary secure access communication channel 190.

As seen in FIG. 1, once temporary secure access communication channel 190 is enabled, operational instruction code 105 is transferred from vulnerability response module 102 to temporary secure access enabled virtual asset 150 via temporary secure access communication channel 190.

Consequently, in one embodiment, operational instruction code 105 for facilitating one or more protective actions to be implemented in the event of a discovered vulnerability, or a suspected action on the part of one or more malicious parties, can be dynamically and reactively inserted into temporary secure access enabled virtual asset 150 through a special temporary secure access communication channel, e.g., temporary secure access communication channel 190, that is distinct from the normal communications channels which may have been compromised or shut down by the malicious party.

In one embodiment, temporary secure access enabled virtual assets, such as temporary secure access enabled virtual asset 150, are generated through a virtual asset creation system, such as a virtual asset template through which the creator of a virtual asset can generate operational logic and assign resources and attributes to the virtual asset, and/or other forms of temporary secure access enabled virtual asset creation data. As noted above, one example of a temporary secure access enabled virtual asset creation template includes, but is not limited to, a virtual appliance used to instantiate virtual assets such as an Amazon Machine Image (AMI).

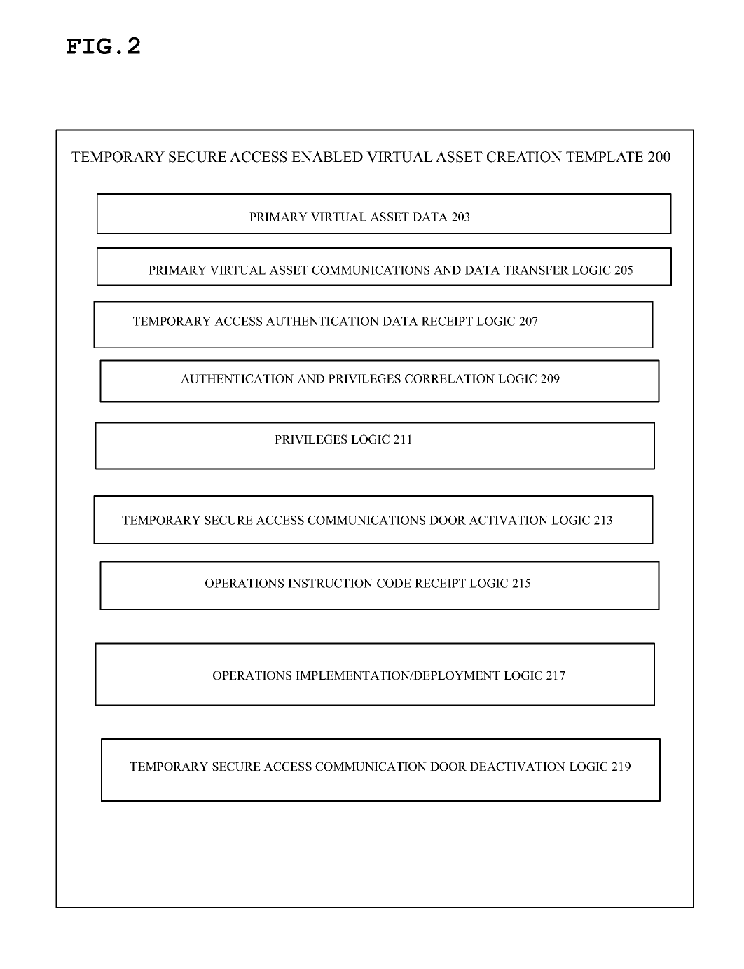

FIG. 2 is a functional diagram of part of the operational logic of a temporary secure access enabled virtual asset creation template 200 for creating a temporary secure access enabled virtual asset, such as temporary secure access enabled virtual asset 150 of FIG. 1, in accordance with one embodiment.

As seen in FIG. 2, in one embodiment, temporary secure access enabled virtual asset creation template 200 includes primary virtual asset data 203.

In one embodiment, primary virtual asset data 203 includes primary virtual asset data, logic and instructions, associated with the temporary secure access enabled virtual asset itself, and/or the normal functions and operations of the temporary secure access enabled virtual asset, and/or the operating environment of the temporary secure access enabled virtual asset, such as a cloud computing environment and/or one or more management systems for the cloud computing environment.

As specific illustrative examples, in various embodiments, the primary virtual asset data includes, but is not limited to, one or more of, data indicating the temporary secure access enabled virtual asset's identification; data indicating the region associated with the temporary secure access enabled virtual asset; data indicating the availability zone associated with the temporary secure access enabled virtual asset; data representing and/or indicating software modules and code residing within, or assigned to, the temporary secure access enabled virtual asset; data indicating a number of software modules residing within, or associated with, the temporary secure access enabled virtual asset; data representing or indicating files and/or file names residing within, or assigned to, the temporary secure access enabled virtual asset; data representing and/or indicating the exact configuration of the temporary secure access enabled virtual asset; data indicating a boot sequence for the temporary secure access enabled virtual asset; any data provided by a hypervisor or virtualization layer associated with the temporary secure access enabled virtual asset; any data provided from a cloud control plane associated with the temporary secure access enabled virtual asset; any data provided by any management system associated with the computing environment of the temporary secure access enabled virtual asset; and/or any combination of “inside” or “normal” operational virtual asset data as discussed herein, and/or as known in the art at the time of filing, and/or as developed after the time of filing.

In one embodiment, using at least part of the temporary secure access enabled virtual asset creation data, a temporary secure access enabled virtual asset can be instantiated, or launched, in a first computing environment. In one embodiment, as a specific illustrative example, the temporary secure access enabled virtual asset is a temporary secure access enabled virtual machine, or temporary secure access enabled server instance, to be launched in a cloud computing environment.

In one embodiment, temporary secure access enabled virtual asset creation template 200 includes primary virtual asset communications and data transfer logic 205. In various embodiments, primary virtual asset communications and data transfer logic 205 includes logic and instructions for providing “normal” communications channels and data transfer mechanisms to be used by the temporary secure access enabled virtual asset once the temporary secure access enabled virtual asset is instantiated, and/or deployed, in the first computing environment.

In one embodiment, temporary secure access enabled virtual asset creation template 200 includes temporary access authentication data receipt logic 207. In one embodiment, temporary access authenticated data receipt logic 207 includes instructions and data for receiving temporary access authentication data from one or more sources outside of the temporary secure access enabled virtual asset to be instantiated using temporary secure access enabled virtual asset creation template 200.

In one embodiment, temporary secure access enabled virtual asset creation template 200 includes authentication and privileges correlation logic 209. In one embodiment authentication and privileges correlation logic 209 includes data and instructions for correlating temporary access authentication data received with one or more associated access and/or operations privileges, and/or sets of privileges, within the temporary secure access enabled virtual assets to be instantiated using temporary secure access enabled virtual asset creation template 200.

In one embodiment, temporary secure access enabled virtual asset creation template 200 includes privileges logic 211 which includes instructions and data for providing various ones, or sets, of privileges and/or access, to be provided when a particular type of temporary access authentication data is received within the temporary secure access enabled virtual assets to be instantiated using temporary secure access enabled virtual asset creation template 200.

In one embodiment, temporary secure access enabled virtual asset creation template 200 includes temporary secure access communication door activation logic 213. In one embodiment, temporary secure access communication door activation logic 213 includes logic and instructions to activate, or “open”, a temporary secure access communications door once temporary access authentication data is received.

In one embodiment, temporary secure access enabled virtual asset creation template 200 includes operations instruction code receipt logic 215. In one embodiment, operations instruction code receipt logic 215 includes data and instructions for receiving operational instruction code through the temporary secure communications channel enabled by the opening of the temporary secure access communication door by temporary secure access communication door activation logic 213.

In one embodiment, temporary secure access enabled virtual asset creation template 200 includes operations implementation/deployment logic 217. In one embodiment, operations implementation/deployment logic 217 provides the access and support needed to deploy the operations indicated in the operation instruction code received by operations instruction code receipt logic 215 in accordance with the privileges data of privileges logic 211 indicated by authentication and privileges correlation logic 209.

In one embodiment, temporary secure access enabled virtual asset creation template 200 includes temporary secure access communication door deactivation logic 219. In one embodiment, temporary secure access communication door deactivation logic 219 includes data and instructions for deactivating the temporary secure access communication door, and therefore disabling the temporary secure communications channel, once the operations indicated in the operation instruction code received by operations instruction code receipt logic 215 are complete.

In one embodiment, a method for providing temporary secure access enabled virtual assets includes providing a virtual asset monitoring system. In one embodiment, the virtual asset monitoring system includes security and response policy data indicating any identified vulnerabilities and response operations associated with identified vulnerabilities.

In accordance with one embodiment, a vulnerability response system is provided that includes temporary access authentication data and operation instruction code for implementing one or more operational responses to identified vulnerabilities indicated by the virtual asset monitoring system.

In accordance with one embodiment, one or more temporary secure access enabled virtual assets are provided. In one embodiment, each temporary secure access enabled virtual asset includes a temporary access authentication data receipt module for receiving at least part of the temporary access authentication data from the vulnerability response system.

In one embodiment, each temporary secure access enabled virtual asset also includes a temporary secure access communication door activation module which, upon receipt of at least part of the temporary access authentication data from the vulnerability response system by the temporary access authentication data receipt module, opens a temporary secure access communications door pre-deployed within the temporary secure access enabled virtual asset.

In one embodiment, once activated, e.g., opened, the temporary secure access communications door provides a temporary secure access communication channel through which the operational instruction code is transferred from the vulnerability response system into the temporary secure access enabled virtual asset. In one embodiment, the operational instruction code then facilitates the deployment of one or more operational responses to identified vulnerabilities indicated by the virtual asset monitoring system.

In one embodiment, once the operational instruction code implements one or more operational responses to identified vulnerabilities indicated by the virtual asset monitoring system, the temporary secure access communications door is de-activated, e.g., is closed, thereby shutting down the temporary secure access communication channel.

Using the temporary secure access enabled virtual assets, and the methods and systems for providing temporary secure access enabled virtual assets, discussed herein, the owner of a virtual asset is provided a mechanism for accessing, scanning, repairing, extracting data from, and/or destroying, a given temporary secure access enabled virtual asset; even in the event that a malicious party has taken control of the temporary secure access enabled virtual asset, and/or the normal communications channels associated with the temporary secure access enabled virtual asset.

In addition, by allowing operational instruction code to be inserted through a temporary secure communications channel directly into the temporary secure access enabled virtual assets, highly sensitive operational code, such as self-destruction code, can be provided to temporary secure access enabled virtual assets at the time it is needed. Consequently, this highly sensitive and potentially dangerous operational code can be kept in a relatively secure location outside the temporary secure access enabled virtual assets until such time as the sensitive operational code is to be used.

In addition, using the temporary secure access enabled virtual assets, and the methods and systems for providing temporary secure access enabled virtual assets discussed herein, not only can an owner of the temporary secure access enabled virtual assets be provided the capability to respond and react to a potentially compromised temporary secure access enabled virtual asset situation but, in some cases, using the temporary secure access communication channel, access to the temporary secure access enabled virtual assets can be accomplished without alerting the malicious party to the fact that various operation instruction code has been inserted into the temporary secure access enabled virtual assets. This provides the owner of the temporary secure access enabled virtual assets the potential capability to take back control of the temporary secure access enabled virtual assets and generate and/or transmit false data, or take other deceptive action, as a countermeasure to the actions of the malicious party.

Therefore, using the temporary secure access enabled virtual assets, and the methods and systems for providing temporary secure access enabled virtual assets discussed herein, virtual assets, and the data processed and stored by virtual assets, are made more secure.

### Process

In accordance with one embodiment, temporary secure access enabled virtual assets are provided that include a temporary secure access communications door. In one embodiment, upon receipt of temporary access authentication data from a source outside the temporary secure access enabled virtual asset, the temporary secure access communications door temporarily allows operational instruction code to be transferred into the temporary secure access enabled virtual asset from a source outside temporary secure access enabled virtual asset.

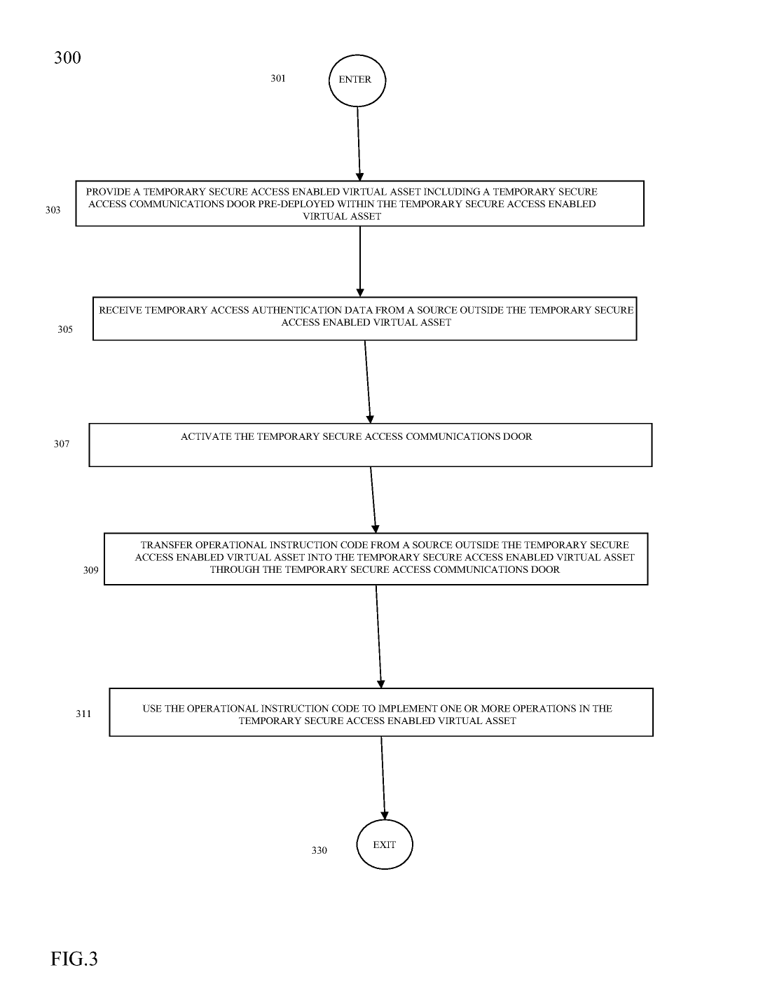

FIG. 3 is a flow chart of a process 300 for providing temporary secure access enabled virtual assets in accordance with one embodiment. In one embodiment, process 300 for providing temporary secure access enabled virtual assets begins at ENTER OPERATION 301 of FIG. 3 and process flow proceeds to PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 303.

In one embodiment, at PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 303 one or more temporary secure access enabled virtual assets are provided with each temporary secure access enabled virtual asset including a temporary secure access communications door pre-deployed within the temporary secure access enabled virtual asset.

In one embodiment, upon receipt of temporary access authentication data from a source outside of the temporary secure access enabled virtual assets, the temporary secure access communications door pre-deployed within the temporary secure access enabled virtual assets of PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 303 opens a temporary secure access communications channel to the temporary secure access enabled virtual asset.

In one embodiment, once one or more temporary secure access enabled virtual assets are provided with each temporary secure access enabled virtual asset including a temporary secure access communications door pre-deployed within the temporary secure access enabled virtual asset at PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 303, process flow proceeds to RECEIVE TEMPORARY ACCESS AUTHENTICATION DATA FROM A SOURCE OUTSIDE THE TEMPORARY SECURE ACCESS ENABLED VIRTUAL ASSET OPERATION 305.

In one embodiment, at RECEIVE TEMPORARY ACCESS AUTHENTICATION DATA FROM A SOURCE OUTSIDE THE TEMPORARY SECURE ACCESS ENABLED VIRTUAL ASSET OPERATION 305 temporary access authentication data is received at the temporary secure access communications door pre-deployed within at least one temporary secure access enabled virtual asset of PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 303.

In one embodiment, once temporary access authentication data is received at the temporary secure access communications door pre-deployed within at least one temporary secure access enabled virtual asset at RECEIVE TEMPORARY ACCESS AUTHENTICATION DATA FROM A SOURCE OUTSIDE THE TEMPORARY SECURE ACCESS ENABLED VIRTUAL ASSET OPERATION 305, process flow proceeds to ACTIVATE THE TEMPORARY SECURE ACCESS COMMUNICATIONS DOOR OPERATION 307.

In one embodiment, at ACTIVATE THE TEMPORARY SECURE ACCESS COMMUNICATIONS DOOR OPERATION 307 the temporary secure access communications door pre-deployed within the temporary secure access enabled virtual asset of RECEIVE TEMPORARY ACCESS AUTHENTICATION DATA FROM A SOURCE OUTSIDE THE TEMPORARY SECURE ACCESS ENABLED VIRTUAL ASSET OPERATION 305 is activated, i.e., “opened.”

In one embodiment, the temporary secure access communications door pre-deployed within the temporary secure access enabled virtual asset being enabled results in the temporary enablement of a temporary secure access communication channel between the outside source of RECEIVE TEMPORARY ACCESS AUTHENTICATION DATA FROM A SOURCE OUTSIDE THE TEMPORARY SECURE ACCESS ENABLED VIRTUAL ASSET OPERATION 305 and the temporary secure access communication enabled virtual asset.

In one embodiment, once the temporary secure access communications door pre-deployed within the temporary secure access enabled virtual asset of RECEIVE TEMPORARY ACCESS AUTHENTICATION DATA FROM A SOURCE OUTSIDE THE TEMPORARY SECURE ACCESS ENABLED VIRTUAL ASSET OPERATION 305 is activated, i.e., “opened” at ACTIVATE THE TEMPORARY SECURE ACCESS COMMUNICATIONS DOOR OPERATION 307, process flow proceeds to TRANSFER OPERATIONAL INSTRUCTION CODE FROM A SOURCE OUTSIDE THE TEMPORARY SECURE ACCESS ENABLED VIRTUAL ASSET INTO THE TEMPORARY SECURE ACCESS ENABLED VIRTUAL ASSET THROUGH THE TEMPORARY SECURE ACCESS COMMUNICATIONS DOOR OPERATION 309.

In one embodiment, at TRANSFER OPERATIONAL INSTRUCTION CODE FROM A SOURCE OUTSIDE THE TEMPORARY SECURE ACCESS ENABLED VIRTUAL ASSET INTO THE TEMPORARY SECURE ACCESS ENABLED VIRTUAL ASSET THROUGH THE TEMPORARY SECURE ACCESS COMMUNICATIONS DOOR OPERATION 309 operational instruction code is transferred to the temporary secure access enabled virtual asset of RECEIVE TEMPORARY ACCESS AUTHENTICATION DATA FROM A SOURCE OUTSIDE THE TEMPORARY SECURE ACCESS ENABLED VIRTUAL ASSET OPERATION 305.

In one embodiment, once the operational instruction code is transferred to the temporary secure access enabled virtual asset of RECEIVE TEMPORARY ACCESS AUTHENTICATION DATA FROM A SOURCE OUTSIDE THE TEMPORARY SECURE ACCESS ENABLED VIRTUAL ASSET OPERATION 305 at TRANSFER OPERATIONAL INSTRUCTION CODE FROM A SOURCE OUTSIDE THE TEMPORARY SECURE ACCESS ENABLED VIRTUAL ASSET INTO THE TEMPORARY SECURE ACCESS ENABLED VIRTUAL ASSET THROUGH THE TEMPORARY SECURE ACCESS COMMUNICATIONS DOOR OPERATION 309, process flow proceeds to USE THE OPERATIONAL INSTRUCTION CODE TO IMPLEMENT ONE OR MORE OPERATIONS IN THE TEMPORARY SECURE ACCESS ENABLED VIRTUAL ASSET OPERATION 311.

In one embodiment, at USE THE OPERATIONAL INSTRUCTION CODE TO IMPLEMENT ONE OR MORE OPERATIONS IN THE TEMPORARY SECURE ACCESS ENABLED VIRTUAL ASSET OPERATION 311 the operational instruction code of TRANSFER OPERATIONAL INSTRUCTION CODE FROM A SOURCE OUTSIDE THE TEMPORARY SECURE ACCESS ENABLED VIRTUAL ASSET INTO THE TEMPORARY SECURE ACCESS ENABLED VIRTUAL ASSET THROUGH THE TEMPORARY SECURE ACCESS COMMUNICATIONS DOOR OPERATION 309 is used to facilitate the deployment of one or more operations.

In one embodiment, at USE THE OPERATIONAL INSTRUCTION CODE TO IMPLEMENT ONE OR MORE OPERATIONS IN THE TEMPORARY SECURE ACCESS ENABLED VIRTUAL ASSET OPERATION 311 the operational instruction code of TRANSFER OPERATIONAL INSTRUCTION CODE FROM A SOURCE OUTSIDE THE TEMPORARY SECURE ACCESS ENABLED VIRTUAL ASSET INTO THE TEMPORARY SECURE ACCESS ENABLED VIRTUAL ASSET THROUGH THE TEMPORARY SECURE ACCESS COMMUNICATIONS DOOR OPERATION 309 is used to facilitate the deployment of one or more operational responses to identified vulnerabilities.

In one embodiment, once the operational instruction code is used to facilitate the deployment of one or more at USE THE OPERATIONAL INSTRUCTION CODE TO IMPLEMENT ONE OR MORE OPERATIONS IN THE TEMPORARY SECURE ACCESS ENABLED VIRTUAL ASSET OPERATION 311, process flow proceeds to EXIT OPERATION 330.

In one embodiment, at EXIT OPERATION 330 process 300 for providing temporary secure access enabled virtual assets is exited to await new data.

Using the temporary secure access enabled virtual assets of process 300 for providing temporary secure access enabled virtual assets, the owner of a temporary secure access enabled virtual asset is provided a mechanism for accessing, scanning, repairing, extracting data from, and/or destroying, a given temporary secure access enabled virtual asset even in the event that a malicious party has taken control of the temporary secure access enabled virtual asset, and/or the normal communications channels associated with the temporary secure access enabled virtual asset.

In addition, by allowing operational instruction code to be inserted through a temporary secure communications channel directly into the temporary secure access enabled virtual assets, highly sensitive operational code, such as self-destruction code, can be provided to temporary secure access enabled virtual assets at the time it is needed. Consequently, using the temporary secure access enabled virtual assets of process 300 for providing temporary secure access enabled virtual assets, this highly sensitive and potentially dangerous operational code can be kept in a relatively secure location outside the temporary secure access enabled virtual assets until such time as the sensitive operational code is to be used.

In addition, using the temporary secure access enabled virtual assets of process 300 for providing temporary secure access enabled virtual assets, not only can an owner of the temporary secure access enabled virtual assets be provided the capability to respond and react to a potentially compromised temporary secure access enabled virtual asset situation but, in some cases, using the temporary secure access communication channel, access to the temporary secure access enabled virtual assets can be accomplished without alerting the malicious party to the fact that various operation instruction code has been inserted into the temporary secure access enabled virtual assets. This provides the owner of the temporary secure access enabled virtual assets the potential capability to take back control of the temporary secure access enabled virtual assets and generate and/or transmit false data, or take other deceptive action, as a countermeasure to the actions of the malicious party.

Therefore, the temporary secure access enabled virtual assets of process 300 for providing temporary secure access enabled virtual assets and the data processed and stored by the temporary secure access enabled virtual assets of process 300 for providing temporary secure access enabled virtual assets, are made more secure.

In accordance with one embodiment, a system for providing temporary secure access enabled virtual assets includes a virtual asset monitoring system. In one embodiment, the virtual asset monitoring system includes security and response policy data indicating any identified vulnerabilities and response operations associated with identified vulnerabilities.

In accordance with one embodiment, a vulnerability response system is provided that includes temporary access authentication data and operation instruction code for implementing one or more operational responses to identified vulnerabilities indicated by the virtual asset monitoring system.

In accordance with one embodiment, one or more temporary secure access enabled virtual assets are provided. In one embodiment, each temporary secure access enabled virtual asset includes a temporary access authentication data receipt module for receiving at least part of the temporary access authentication data from the vulnerability response system.

In one embodiment, each temporary secure access enabled virtual asset also includes a temporary secure access communication door activation module that, upon receipt of at least part of the temporary access authentication data from the vulnerability response system by the temporary access authentication data receipt module, temporarily opens a temporary secure access communications door pre-deployed within the temporary secure access enabled virtual asset.

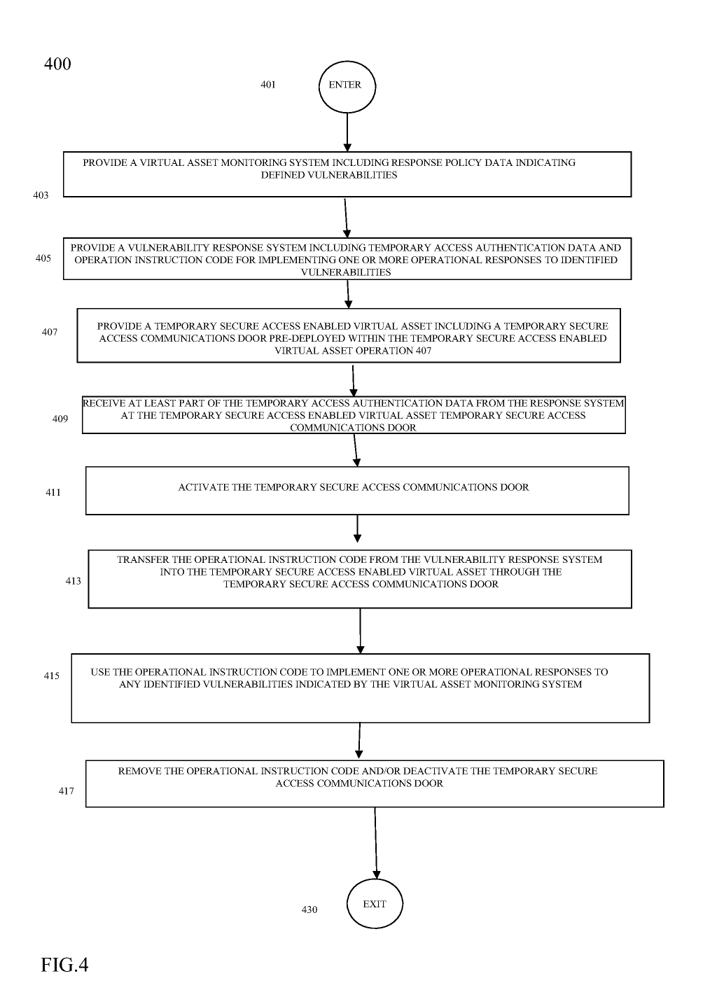

FIG. 4 is a flow chart of a process 400 for providing temporary secure access enabled virtual assets in accordance with one embodiment. In one embodiment, process 400 for providing temporary secure access enabled virtual assets begins at ENTER OPERATION 401 of FIG. 4 and process flow proceeds to PROVIDE A VIRTUAL ASSET MONITORING SYSTEM INCLUDING RESPONSE POLICY DATA INDICATING DEFINED VULNERABILITIES OPERATION 403.

In one embodiment, at PROVIDE A VIRTUAL ASSET MONITORING SYSTEM INCLUDING RESPONSE POLICY DATA INDICATING DEFINED VULNERABILITIES OPERATION 403 a virtual asset monitoring system is provided.

In one embodiment, the virtual asset monitoring system of PROVIDE A VIRTUAL ASSET MONITORING SYSTEM INCLUDING RESPONSE POLICY DATA INDICATING DEFINED VULNERABILITIES OPERATION 403 includes security and response policy data indicating any identified vulnerabilities and response operations associated with identified vulnerabilities.

In one embodiment, the virtual asset monitoring system of PROVIDE A VIRTUAL ASSET MONITORING SYSTEM INCLUDING RESPONSE POLICY DATA INDICATING DEFINED VULNERABILITIES OPERATION 403 includes alert data indicating the possibility that one or more temporary secure access enabled virtual assets has been compromised, and/or includes one of the identified potential vulnerabilities, and/or otherwise requires some form of corrective and/or protective action.

In one embodiment, once a virtual asset monitoring system is provided at PROVIDE A VIRTUAL ASSET MONITORING SYSTEM INCLUDING RESPONSE POLICY DATA INDICATING DEFINED VULNERABILITIES OPERATION 403, process flow proceeds to PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405.

In one embodiment, at PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 a vulnerability response system is provided.

In one embodiment, the vulnerability response system of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 includes temporary access authentication data and operation instruction code for implementing one or more operational responses to identified vulnerabilities indicated by the virtual asset monitoring system of PROVIDE A VIRTUAL ASSET MONITORING SYSTEM INCLUDING RESPONSE POLICY DATA INDICATING DEFINED VULNERABILITIES OPERATION 403.

In one embodiment, the temporary access authentication data of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 is data not strictly connected to the normal operation and/or communications channels associated with the temporary secure access enabled virtual assets themselves, or the operating environment of the temporary secure access enabled virtual assets, but rather includes special proprietary authentication data and protocols for opening a special temporary secure access communication channel to the temporary secure access enabled virtual assets that is not available to other assets, architectures, structures, and parties in the computing environment of the temporary secure access enabled virtual assets.

As specific illustrative examples, in various embodiments, the temporary access authentication data of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 can include various types of secrets. As used herein, the term “secrets” includes any information, credentials, or other devices, necessary to access one or more resources and/or computing systems.

Specific illustrative examples of secrets include, but are not limited to, usernames; passwords; passphrases; encryption keys; digital certificates; multifactor authentication data; account numbers; identification numbers; and/or any other information, credentials, data, devices, and/or mechanisms used to control access to various systems, resources, file systems and any other persistent storage, and data, and that are required for such access, as discussed herein, and/or as known/available in the art at the time of filing, and/or as developed/made available after the time of filing.

In various embodiments, the temporary access authentication data of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 can also include, but is not limited to, data representing: a number, such as a randomly generated number; a group of letters, such as a randomly generated group of letters; a word, such as a randomly generated password; a string of words, such as a randomly generated passphrase or nonsense phrase; data associated with the owner of the temporary access authentication enabled virtual asset, such as a serial number, identification key, or operation parameter associated with an application or service, or system that owns the temporary access authentication enabled virtual asset; personal data associated with the owner of an account associated with the temporary access authentication enabled virtual asset, such physical attributes, e.g., hair color, or hair colors, or eye color, of the owner of an account associated with the temporary access authentication enabled virtual asset, or an address, or phone number, or other personal data associated the owner of an account associated with the temporary access authentication enabled virtual asset; any form of certificate, key, or token; and/or any form of temporary access authentication data, or factors, as discussed herein, and/or as known in the art at the time of filing, and/or as developed after the time of filing.

Consequently, in one embodiment, the temporary access authentication data of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 can include different types of authentication data such as, but not limited to, different temporary access authentication keys.

In one embodiment, the operation instruction code of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 includes one or more sets of operational instruction code.

In one embodiment, the vulnerability response module operational instruction code of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 includes instructions and data which, when deployed, or “inserted”, into temporary secure access enabled virtual assets performs one or more corrective or protective actions within the temporary secure access enabled virtual assets.

In various embodiments, the vulnerability response module operational instruction code of PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405 includes data and instructions for, but not limited to, any of the following operations: performing one or more scans on all or part of the logic and data contained and/or processed by the temporary secure access enabled virtual assets, in one embodiment to attempt to identify malicious code or activity; obtaining data from the temporary secure access enabled virtual assets; destroying data within the temporary secure access enabled virtual assets; directing a transfer of data from within the temporary secure access enabled virtual assets to a location outside the temporary secure access enabled virtual assets, e.g., pulling data from the temporary secure access enabled virtual assets prior to destroying the temporary secure access enabled virtual assets; closing down one or more communications channels used by the temporary secure access enabled virtual assets; shutting down, or off, one or more capabilities of the temporary secure access enabled virtual assets; aborting one or more operations being performed by the temporary secure access enabled virtual assets; destroying the temporary secure access enabled virtual assets; and/or generating and/or transferring incorrect and/or deceptive data from the temporary secure access enabled virtual assets to a location outside the temporary secure access enabled virtual asset, such as a location or source associated with a malicious party.

In one embodiment, once a vulnerability response system is provided at PROVIDE A VULNERABILITY RESPONSE SYSTEM INCLUDING TEMPORARY ACCESS AUTHENTICATION DATA AND OPERATION INSTRUCTION CODE FOR IMPLEMENTING ONE OR MORE OPERATIONAL RESPONSES TO IDENTIFIED VULNERABILITIES OPERATION 405, process flow proceeds to PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 407.

In one embodiment, at PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 407 one or more temporary secure access enabled virtual assets are provided with each temporary secure access enabled virtual asset including a temporary secure access communications door pre-deployed within the temporary secure access enabled virtual asset.

In one embodiment, upon receipt of at least part of the temporary access authentication data from the vulnerability response system of PROVIDE A VULNERABILITY RESPONSE SYSTEM INCLUDING TEMPORARY ACCESS AUTHENTICATION DATA OPERATION INSTRUCTION CODE FOR IMPLEMENTING ONE OR MORE OPERATIONAL RESPONSES TO IDENTIFIED VULNERABILITIES OPERATION 405, the temporary secure access communications door pre-deployed within the temporary secure access enabled virtual assets of PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 407 opens a temporary secure access communications channel between the vulnerability response system of PROVIDE A VULNERABILITY RESPONSE SYSTEM INCLUDING TEMPORARY ACCESS AUTHENTICATION DATA OPERATION INSTRUCTION CODE FOR IMPLEMENTING ONE OR MORE OPERATIONAL RESPONSES TO IDENTIFIED VULNERABILITIES OPERATION 405 and the temporary secure access enabled virtual asset.

In one embodiment, once one or more temporary secure access enabled virtual assets are provided with each temporary secure access enabled virtual asset including a temporary secure access communications door pre-deployed within the temporary secure access enabled virtual asset at PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 407, process flow proceeds to RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409.

In one embodiment, at RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409 at least part of the temporary access authentication data from the vulnerability response system of PROVIDE A VULNERABILITY RESPONSE SYSTEM INCLUDING TEMPORARY ACCESS AUTHENTICATION DATA OPERATION INSTRUCTION CODE FOR IMPLEMENTING ONE OR MORE OPERATIONAL RESPONSES TO IDENTIFIED VULNERABILITIES OPERATION 405 is received at the temporary secure access communications door pre-deployed within at least one temporary secure access enabled virtual asset of PROVIDE A TEMPORARY SECURE ACCESS ENABLED VIRTUAL ASSET INCLUDING A TEMPORARY SECURE ACCESS COMMUNICATIONS DOOR PRE-DEPLOYED WITHIN THE TEMPORARY SECURE ACCESS ENABLED VIRTUAL ASSET OPERATION 407.

In one embodiment, once at least part of the temporary access authentication data from the vulnerability response system is received at the temporary secure access communications door pre-deployed within at least one temporary secure access enabled virtual asset at RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409, process flow proceeds to ACTIVATE THE TEMPORARY SECURE ACCESS COMMUNICATIONS DOOR OPERATION 411.

In one embodiment, at ACTIVATE THE TEMPORARY SECURE ACCESS COMMUNICATIONS DOOR OPERATION 411 the temporary secure access communications door pre-deployed within the temporary secure access enabled virtual asset of RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409 is activated, i.e., “opened.”

In one embodiment, the temporary secure access communications door pre-deployed within the temporary secure access enabled virtual asset being enabled results in the temporary enablement of a temporary secure access communication channel between the vulnerability response system of PROVIDE A VULNERABILITY RESPONSE SYSTEM INCLUDING TEMPORARY ACCESS AUTHENTICATION DATA OPERATION INSTRUCTION CODE FOR IMPLEMENTING ONE OR MORE OPERATIONAL RESPONSES TO IDENTIFIED VULNERABILITIES OPERATION 405 and the temporary secure access communication enabled virtual asset of RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409.

In one embodiment, once the temporary secure access communications door pre-deployed within the temporary secure access enabled virtual asset of RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409 is activated, i.e., “opened” at ACTIVATE THE TEMPORARY SECURE ACCESS COMMUNICATIONS DOOR OPERATION 411, process flow proceeds to TRANSFER THE OPERATIONAL INSTRUCTION CODE FROM THE VULNERABILITY RESPONSE SYSTEM INTO THE TEMPORARY SECURE ACCESS ENABLED VIRTUAL ASSET THROUGH THE TEMPORARY SECURE ACCESS COMMUNICATIONS DOOR OPERATION 413.

In one embodiment, at TRANSFER THE OPERATIONAL INSTRUCTION CODE FROM THE VULNERABILITY RESPONSE SYSTEM INTO THE TEMPORARY SECURE ACCESS ENABLED VIRTUAL ASSET THROUGH THE TEMPORARY SECURE ACCESS COMMUNICATIONS DOOR OPERATION 413 the operational instruction code of the vulnerability response system of PROVIDE A VULNERABILITY RESPONSE SYSTEM INCLUDING TEMPORARY ACCESS AUTHENTICATION DATA OPERATION INSTRUCTION CODE FOR IMPLEMENTING ONE OR MORE OPERATIONAL RESPONSES TO IDENTIFIED VULNERABILITIES OPERATION 405 is transferred to the temporary secure access enabled virtual asset of RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409.

In one embodiment, once the operational instruction code of the vulnerability response system of PROVIDE A VULNERABILITY RESPONSE SYSTEM INCLUDING TEMPORARY ACCESS AUTHENTICATION DATA OPERATION INSTRUCTION CODE FOR IMPLEMENTING ONE OR MORE OPERATIONAL RESPONSES TO IDENTIFIED VULNERABILITIES OPERATION 405 is transferred to the temporary secure access enabled virtual asset of RECEIVE AT LEAST PART OF THE TEMPORARY ACCESS AUTHENTICATION DATA FROM THE RESPONSE SYSTEM AT THE TEMPORARY SECURE ACCESS ENABLED VIRTUAL ASSET TEMPORARY SECURE ACCESS COMMUNICATIONS DOOR OPERATION 409 at TRANSFER THE OPERATIONAL INSTRUCTION CODE FROM THE VULNERABILITY RESPONSE SYSTEM INTO THE TEMPORARY SECURE ACCESS ENABLED VIRTUAL ASSET THROUGH THE TEMPORARY SECURE ACCESS COMMUNICATIONS DOOR OPERATION 413, process flow proceeds to USE THE OPERATIONAL INSTRUCTION CODE TO IMPLEMENT ONE OR MORE OPERATIONAL RESPONSES TO ANY IDENTIFIED VULNERABILITIES INDICATED BY THE VIRTUAL ASSET MONITORING SYSTEM OPERATION 415.

In one embodiment, at USE THE OPERATIONAL INSTRUCTION CODE TO IMPLEMENT ONE OR MORE OPERATIONAL RESPONSES TO ANY IDENTIFIED VULNERABILITIES INDICATED BY THE VIRTUAL ASSET MONITORING SYSTEM OPERATION 415 the operational instruction code of TRANSFER THE OPERATIONAL INSTRUCTION CODE FROM THE VULNERABILITY RESPONSE SYSTEM INTO THE TEMPORARY SECURE ACCESS ENABLED VIRTUAL ASSET THROUGH THE TEMPORARY SECURE ACCESS COMMUNICATIONS DOOR OPERATION 413 is used to facilitate the deployment of one or more operational responses to identified vulnerabilities indicated by the virtual asset monitoring system of PROVIDE A VIRTUAL ASSET MONITORING SYSTEM INCLUDING RESPONSE POLICY DATA INDICATING DEFINED VULNERABILITIES OPERATION 403.

In one embodiment, once the operational instruction code is used to facilitate the deployment of one or more operational responses to identified vulnerabilities indicated by the virtual asset monitoring system at USE THE OPERATIONAL INSTRUCTION CODE TO IMPLEMENT ONE OR MORE OPERATIONAL RESPONSES TO ANY IDENTIFIED VULNERABILITIES INDICATED BY THE VIRTUAL ASSET MONITORING SYSTEM OPERATION 415, process flow proceeds to REMOVE THE OPERATIONAL INSTRUCTION CODE AND/OR DEACTIVATE THE TEMPORARY SECURE ACCESS COMMUNICATIONS DOOR OPERATION 419.

In one embodiment, once the operational instruction code implements one or more operational responses to identified vulnerabilities indicated by the virtual asset monitoring system at USE THE OPERATIONAL INSTRUCTION CODE TO IMPLEMENT ONE OR MORE OPERATIONAL RESPONSES TO ANY IDENTIFIED VULNERABILITIES INDICATED BY THE VIRTUAL ASSET MONITORING SYSTEM OPERATION 415, the temporary secure access communications door is de-activated, e.g., is closed, at REMOVE THE OPERATIONAL INSTRUCTION CODE AND/OR DEACTIVATE THE TEMPORARY SECURE ACCESS COMMUNICATIONS DOOR OPERATION 419, thereby shutting down the temporary secure access communication channel.

In one embodiment, once the temporary secure access communications door is de-activated, e.g., is closed, at REMOVE THE OPERATIONAL INSTRUCTION CODE AND/OR DEACTIVATE THE TEMPORARY SECURE ACCESS COMMUNICATIONS DOOR OPERATION 419, process flow proceeds to EXIT OPERATION 430.

In one embodiment, at EXIT OPERATION 430 process 400 for providing temporary secure access enabled virtual assets is exited to await new data.

Using process 400 for providing temporary secure access enabled virtual assets, the owner of a virtual asset is provided a mechanism for accessing, scanning, repairing, extracting data from, and/or destroying, a given temporary secure access enabled virtual asset even in the event that a malicious party has taken control of the temporary secure access enabled virtual asset, and/or the normal communications channels associated with the temporary secure access enabled virtual asset.

In addition, by allowing operational instruction code to be inserted through a temporary secure communications channel directly into the temporary secure access enabled virtual assets, highly sensitive operational code, such as self-destruction code, can be provided to temporary secure access enabled virtual assets at the time it is needed. Consequently, using process 400 for providing temporary secure access enabled virtual assets, this highly sensitive and potentially dangerous operational code can be kept in a relatively secure location outside the temporary secure access enabled virtual assets until such time as the sensitive operational code is to be used.

In addition, using process 400 for providing temporary secure access enabled virtual assets, not only can an owner of the temporary secure access enabled virtual assets be provided the capability to respond and react to a potentially compromised temporary secure access enabled virtual asset situation but, in some cases, using the temporary secure access communication channel, access to the temporary secure access enabled virtual assets can be accomplished without alerting the malicious party to the fact that various operation instruction code has been inserted into the temporary secure access enabled virtual assets. This provides the owner of the temporary secure access enabled virtual assets the potential capability to take back control of the temporary secure access enabled virtual assets and generate and/or transmit false data, or take other deceptive action, as a countermeasure to the actions of the malicious party.

Therefore, process 400 for providing temporary secure access enabled virtual assets, virtual assets, and the data processed and stored by virtual assets, are made more secure.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for providing temporary secure access enabled virtual assets comprising:
a virtual asset monitoring and vulnerability response system, the virtual asset monitoring and vulnerability response system including temporary access authentication data; and
providing a temporary secure access enabled virtual asset, the temporary secure access enabled virtual asset including a temporary secure access communications door which, upon receipt of at least part of the temporary access authentication data from the virtual asset monitoring and vulnerability response system, temporarily allows operational instruction code to be transferred into the temporary secure access enabled virtual asset from the virtual asset monitoring and vulnerability response system.

2. The system for providing temporary secure access enabled virtual assets of claim 1 wherein the virtual asset monitoring and vulnerability response system is implemented, at least in part, in a first computing environment and the temporary secure access enabled virtual asset is implemented, at least in part, in a second computing environment, the second computing environment being distinct from the first computing environment.

3. The system for providing temporary secure access enabled virtual assets of claim 2 wherein the first computing environment is a data center associated with an owner of the temporary secure access enabled virtual asset.

4. The system for providing temporary secure access enabled virtual assets of claim 2 wherein the second computing environment is a cloud computing environment in which the temporary secure access enabled virtual asset is instantiated.

5. The system for providing temporary secure access enabled virtual assets of claim 1 wherein the temporary secure access enabled virtual asset is selected from the group of the temporary secure access enabled virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

6. The system for providing temporary secure access enabled virtual assets of claim 1 wherein at least part of the temporary access authentication data received from the virtual asset monitoring and vulnerability response system includes data selected from the group of temporary access authentication data consisting of:
one or more digital certificates;
one or more digital keys;
one or more randomly generated numbers;
one or more randomly generated letters;
a randomly generated password;
a randomly generated passphrase;
data associated with the owner of the virtual asset;
personal data associated with the owner of an account associated with the virtual asset;
creation/launch restrictions associated with the virtual asset;
a token; and
any combination thereof.

7. The system for providing temporary secure access enabled virtual assets of claim 1 wherein the temporary secure access enabled virtual asset includes one or more types of operational privileges to be granted in response to receipt of the temporary access authentication data from the virtual asset monitoring and vulnerability response system.

8. The system for providing temporary secure access enabled virtual assets of claim 7 wherein the temporary access authentication data received from the virtual asset monitoring and vulnerability response system includes one or more authentication keys and the one or more operational privileges to be granted in response to the temporary access authentication data from the virtual asset monitoring and vulnerability response system are selected based on the authentication key included in the temporary access authentication data.

9. The system for providing temporary secure access enabled virtual assets of claim 1 wherein the operational instruction code transferred into the temporary secure access enabled virtual asset from the virtual asset monitoring and vulnerability response system includes operational instruction code for performing one or more operations selected from the group of operations consisting of:
performing a scan of selected data within the temporary secure access enabled virtual asset;
obtaining data from the temporary secure access enabled virtual asset;
directing a transfer of data from within the temporary secure access enabled virtual asset to a location outside the temporary secure access enabled virtual asset;
closing down one or more communications channels used by the temporary secure access enabled virtual asset;
closing down one or more capabilities of the temporary secure access enabled virtual asset;
aborting one or more operations performed by the temporary secure access enabled virtual asset;
destroying the temporary secure access enabled virtual asset; and
generating and/or transferring incorrect and/or deceptive data from the temporary secure access enabled virtual asset to a location outside the temporary secure access enabled virtual asset.

10. A temporary secure access enabled virtual asset comprising:
a temporary secure access communications door that upon receipt of temporary access authentication data from a source outside the temporary secure access enabled virtual asset, temporarily allows operational instruction code to be transferred into the temporary secure access enabled virtual asset from a source outside temporary secure access enabled virtual asset.

11. The temporary secure access enabled virtual asset of claim 10 wherein the source outside temporary secure access enabled virtual asset is implemented, at least in part, in a first computing environment and the temporary secure access enabled virtual asset is implemented, at least in part, in a second computing environment, the second computing environment being distinct from the first computing environment.

12. The temporary secure access enabled virtual asset of claim 11 wherein the first computing environment is a data center associated with an owner of the temporary secure access enabled virtual asset.

13. The temporary secure access enabled virtual asset of claim 11 wherein the second computing environment is a cloud computing environment in which the temporary secure access enabled virtual asset is instantiated.

14. The temporary secure access enabled virtual asset of claim 10 wherein the temporary secure access enabled virtual asset is selected from the group of the temporary secure access enabled virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

15. The temporary secure access enabled virtual asset of claim 10 wherein at least part of the temporary access authentication data includes data selected from the group of temporary access authentication data consisting of:
one or more digital certificates;
one or more digital keys;
one or more randomly generated numbers;
one or more randomly generated letters;
a randomly generated password;
a randomly generated passphrase;
data associated with the owner of the virtual asset;
personal data associated with the owner of an account associated with the virtual asset;
creation/launch restrictions associated with the virtual asset;
a token; and
any combination thereof.

16. The temporary secure access enabled virtual asset of claim 10 further comprising:
one or more types of operational privileges to be granted in response to the temporary access authentication data.

17. The temporary secure access enabled virtual asset of claim 16 wherein the temporary access authentication data includes one or more authentication keys and the one or more operational privileges to be granted in response to the temporary access authentication data are selected based on the authentication key included in the temporary access authentication data.

18. The temporary secure access enabled virtual asset of claim 10 wherein the operational instruction code transferred into the temporary secure access enabled virtual asset includes operational instruction code for performing one or more operations selected from the group of operations consisting of:
performing a scan of selected data within the temporary secure access enabled virtual asset;
obtaining data from the temporary secure access enabled virtual asset;
directing a transfer of data from within the temporary secure access enabled virtual asset to a location outside the temporary secure access enabled virtual asset;
closing down one or more communications channels used by the temporary secure access enabled virtual asset;
shutting down one or more capabilities of the temporary secure access enabled virtual asset;
aborting one or more operations performed by the temporary secure access enabled virtual asset;
destroying the temporary secure access enabled virtual asset; and
generating and/or transferring incorrect and/or deceptive data from the temporary secure access enabled virtual asset to a location outside the temporary secure access enabled virtual asset.

19. A temporary secure access enabled virtual asset comprising:
a temporary access authentication data receipt module for receiving temporary access authentication data from a source outside temporary secure access enabled virtual asset; and
a temporary secure access communication door activation module that, upon receipt of at least part of the temporary access authentication data from a source outside temporary secure access enabled virtual asset by the temporary access authentication data receipt module, temporarily opens a temporary secure access communications door and allows operational instruction code to be transferred into the temporary secure access enabled virtual asset from a source outside temporary secure access enabled virtual asset.

20. The temporary secure access enabled virtual asset of claim 19 wherein the source outside the temporary secure access enabled virtual asset is implemented, at least in part, in a first computing environment and the temporary secure access enabled virtual asset is implemented, at least in part, in a second computing environment, the second computing environment being distinct from the first computing environment.

21. The temporary secure access enabled virtual asset of claim 20 wherein the first computing environment is a data center associated with an owner of the temporary secure access enabled virtual asset.

22. The temporary secure access enabled virtual asset of claim 20 wherein the second computing environment is a cloud computing environment in which the temporary secure access enabled virtual asset is instantiated.

23. The temporary secure access enabled virtual asset of claim 19 wherein the temporary secure access enabled virtual asset is selected from the group of the temporary secure access enabled virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

24. The temporary secure access enabled virtual asset of claim 19 wherein at least part of the temporary access authentication data includes data selected from the group of temporary access authentication data consisting of:
one or more digital certificates;
one or more digital keys;
one or more randomly generated numbers;
one or more randomly generated letters;
a randomly generated password;
a randomly generated passphrase;
data associated with the owner of the virtual asset;
personal data associated with the owner of an account associated with the virtual asset;
creation/launch restrictions associated with the virtual asset;
a token; and
any combination thereof.

25. The temporary secure access enabled virtual asset of claim 19 further comprising:
an access privileges module, the access privileges module including one or more types of operational privileges to be granted in response to receipt of the temporary access authentication data by the temporary access authentication data receipt module.

26. The temporary secure access enabled virtual asset of claim 25 wherein the temporary access authentication data includes one or more authentication keys and the one or more operational privileges to be granted in response to the temporary access authentication data are selected based on the authentication key included in the temporary access authentication data.

27. The temporary secure access enabled virtual asset of claim 19 wherein the operational instruction code transferred into the temporary secure access enabled virtual asset includes operational instruction code for performing one or more operations selected from the group of operations consisting of:
performing a scan of selected data within the temporary secure access enabled virtual asset;
obtaining data from the temporary secure access enabled virtual asset;
directing a transfer of data from within the temporary secure access enabled virtual asset to a location outside the temporary secure access enabled virtual asset;
closing down one or more communications channels used by the temporary secure access enabled virtual asset;
shutting down one or more capabilities of the temporary secure access enabled virtual asset;
aborting one or more operations performed by the temporary secure access enabled virtual asset;
destroying the temporary secure access enabled virtual asset; and
generating and transferring incorrect and/or deceptive data from the temporary secure access enabled virtual asset to a location outside the temporary secure access enabled virtual asset.

28. A system for providing temporary secure access enabled virtual assets comprising:
a virtual asset monitoring system including security and response policy data indicating any identified vulnerabilities and response operations associated with identified vulnerabilities;
a vulnerability response system including temporary access authentication data and operation instruction code;
one or more temporary secure access enabled virtual assets, each temporary secure access enabled virtual asset including:
a temporary access authentication data receipt module for receiving at least part of the temporary access authentication data from the vulnerability response system; and
a temporary secure access communication door activation module that, upon receipt of at least part of the temporary access authentication data from the vulnerability response system by the temporary access authentication data receipt module, temporarily opens a temporary secure access communications door and allows the operational instruction code to be transferred into the temporary secure access enabled virtual asset from the vulnerability response system.

29. The system for providing temporary secure access enabled virtual assets of claim 28 wherein the virtual asset monitoring system, and/or the vulnerability response system, is implemented, at least in part, in a first computing environment and the temporary secure access enabled virtual asset is implemented, at least in part, in a second computing environment, the second computing environment being distinct from the first computing environment.

30. The system for providing temporary secure access enabled virtual assets of claim 29 wherein the first computing environment is a data center associated with an owner of the temporary secure access enabled virtual asset.

31. The system for providing temporary secure access enabled virtual assets of claim 29 wherein the second computing environment is a cloud computing environment in which the temporary secure access enabled virtual asset is instantiated.

32. The system for providing temporary secure access enabled virtual assets of claim 28 wherein at least one of the one or more temporary secure access enabled virtual assets is selected from the group of the temporary secure access enabled virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

33. The system for providing temporary secure access enabled virtual assets of claim 28 wherein the vulnerability response system transfers the operation instruction code to a temporary secure access enabled virtual asset in response to a vulnerability being identified by the virtual asset monitoring system in accordance with the security and response policy data of the virtual asset monitoring system.

34. The system for providing temporary secure access enabled virtual assets of claim 28 wherein at least part of the temporary access authentication data includes data selected from the group of temporary access authentication data consisting of:
one or more digital certificates;
one or more digital keys;
one or more randomly generated numbers;
one or more randomly generated letters;
a randomly generated password;
a randomly generated passphrase;
data associated with the owner of the virtual asset;
personal data associated with the owner of an account associated with the virtual asset;
creation/launch restrictions associated with the virtual asset;
a token; and
any combination thereof.

35. The system for providing temporary secure access enabled virtual assets of claim 28 wherein each temporary secure access enabled virtual asset including the further includes:
an access privileges module, the access privileges module including one or more types of operational privileges to be granted in response to receipt of the temporary access authentication data by the temporary access authentication data receipt module.

36. The system for providing temporary secure access enabled virtual assets of claim 35 wherein the temporary access authentication data includes one or more authentication keys and the one or more operational privileges to be granted in response to the temporary access authentication data are selected based on the authentication key included in the temporary access authentication data.

37. The system for providing temporary secure access enabled virtual assets of claim 28 wherein the operational instruction code transferred into the temporary secure access enabled virtual asset includes operational instruction code for performing one or more operations selected from the group of operations consisting of:
performing a scan of selected data within the temporary secure access enabled virtual asset;
obtaining data from the temporary secure access enabled virtual asset;
directing a transfer of data from within the temporary secure access enabled virtual asset to a location outside the temporary secure access enabled virtual asset;
closing down one or more communications channels used by the temporary secure access enabled virtual asset;
shutting down one or more capabilities of the temporary secure access enabled virtual asset;
aborting one or more operations performed by the temporary secure access enabled virtual asset;
destroying the temporary secure access enabled virtual asset; and
generating and transferring incorrect and/or deceptive data from the temporary secure access enabled virtual asset to a location outside the temporary secure access enabled virtual asset.
